(19) United States
(12) Patent Application Publication
(10) Pub. No.: US 2015/0220434 A1
(43) Pub. Date: Aug. 6, 2015

(54) ELECTRONIC DEVICE AND METHOD FOR EXECUTING GARBAGE COLLECTION

(71) Applicant: Samsung Electronics Co., Ltd., Suwon-si (KR)

(72) Inventor: Do-Kyou LEE, Yongin-si (KR)

(73) Assignee: Samsung Electronics Co., Ltd., Suwon-si (KR)

(21) Appl. No.: 14/186,781

(22) Filed: Feb. 21, 2014

(30) Foreign Application Priority Data
Feb. 5, 2014 (KR) 10-2014-0013262

(51) Int. Cl. G06F 12/02

(52) U.S. Cl. CPC G06F 12/0269; G06F 2212/702

(57) ABSTRACT

A method for executing garbage collection in an electronic device is provided. The method includes executing garbage collection on a memory of the electronic device, determining a propriety of the garbage collection, and adjusting a control variable for determining an execution time-point of a next garbage collection based on the propriety of the garbage collection.

### CROSS-REFERENCE TO RELATED APPLICATION(S)

This application claims the benefit under 35 U.S.C. §119(a) of a Korean patent application filed on Feb. 5, 2014 in the Korean Intellectual Property Office and assigned Serial number 10-2014-0013262, the entire disclosure of which is hereby incorporated by reference.

### TECHNICAL FIELD

The present disclosure relates to an apparatus and a method for executing garbage collection in an electronic device. More particularly, the present disclosure relates to a method for preventing reduction in memory efficiency by executing a garbage collection in an electronic device.

### BACKGROUND

An electronic device may use a memory for storing data for processing. For example, the electronic device may repeatedly perform writing and erasing of data stored in the memory.

When writing and erasing of data stored in the memory are repeatedly performed, an available space for data allocation may be insufficient in the memory of the electronic device because storage areas occupied by unusable data (i.e., garbage or object that are no longer in use by the electronic device) where data cannot be allocated may increase between areas in which data is allocated. In this case, the electronic device may increase an available space by executing garbage collection to reclaim storage areas of the memory occupied by unusable data and generating free segments.

The electronic device may execute garbage collection at an execution time-point for garbage collection determined based on memory usage. Therefore, when valid data is continuously allocated to the memory, the electronic device may frequently execute garbage collection causing overhead and reduction in memory efficiency of the electronic device.

Therefore, a need exists for an apparatus and a method for preventing reduction in memory efficiency by executing garbage collection in an electronic device.

The above information is presented as background information only to assist with an understanding of the present disclosure. No determination has been made, and no assertion is made, as to whether any of the above might be applicable as prior art with regard to the present disclosure.

### SUMMARY

Aspects of the present disclosure are to address at least the above-mentioned problems and/or disadvantages and to provide at least the advantages described below. Accordingly, an aspect of the present disclosure is to provide an apparatus and a method for preventing reduction in memory efficiency by executing garbage collection in an electronic device.

Another aspect of the present disclosure is to provide an apparatus and a method for controlling a number of times of execution of garbage collection in an electronic device.

Another aspect of the present disclosure is to provide an apparatus and a method for adjusting an execution time-point control variable for garbage collection based on a result of garbage collection in an electronic device.

Another aspect of the present disclosure is to provide an apparatus and a method for adjusting an execution time-point control variable for garbage collection based on the amount of memory resources reclaimed through garbage collection in an electronic device.

Another aspect of the present disclosure is to provide an apparatus and a method for adjusting an execution time-point control variable for garbage collection based on the amount of memory resources reclaimed through garbage collection and a garbage collection cycle in an electronic device.

In accordance with an aspect of the present disclosure, a method for executing garbage collection in an electronic device is provided. The method includes executing garbage collection on a memory of the electronic device, determining a propriety of the garbage collection, and adjusting a control variable for determining an execution time-point of a next garbage collection based on the propriety of the garbage collection.

In accordance with another aspect of the present disclosure, an electronic device is provided. The electronic device includes a memory, and a processor configured to execute garbage collection on the memory and to adjust a control variable for determining an execution time-point of a next garbage collection based on a propriety of the garbage collection.

In accordance with another aspect of the present disclosure, a method for executing garbage collection in an electronic device is provided. The method includes executing garbage collection on a memory of the electronic device, determining a propriety of the garbage collection, and, when the garbage collection is improper, updating one or more control variables of a memory utilization, a minimum value of an available memory space, and a maximum value of the available memory space, which are used to determine the execution time-point for next garbage collection.

Other aspects, advantages, and salient features of the disclosure will become apparent to those skilled in the art from the following detailed description, which, taken in conjunction with the annexed drawings, discloses various embodiments of the present disclosure.

### BRIEF DESCRIPTION OF THE DRAWINGS

The above and other aspects, features, and advantages of certain embodiments of the present disclosure will be more apparent from the following description taken in conjunction with the accompanying drawings, in which:

FIG. 1 illustrates a block diagram of an electronic device according to an embodiment of the present disclosure;

FIG. 2 illustrates a block diagram of a processor according to an embodiment of the present disclosure;

FIG. 3 illustrates a process of adjusting an execution time-point control variable for garbage collection in an electronic device according to an embodiment of the present disclosure;

FIG. 4 illustrates a process of adjusting an execution time-point control variable for garbage collection based on a propriety of garbage collection in an electronic device according to an embodiment of the present disclosure;

FIG. 5 illustrates a process for determining a propriety of garbage collection in an electronic device according to an embodiment of the present disclosure;

FIGS. 6A and 6B illustrate a memory configuration according to garbage collection according to an embodiment of the present disclosure;

FIGS. 7A and 7B illustrate a memory configuration according to garbage collection according to an embodiment of the present disclosure; and

FIG. 8 illustrates a garbage collection execution time-point according to an embodiment of the present disclosure.

Throughout the drawings, it should be noted that like reference numbers are used to depict the same or similar elements, features, and structures.

### DETAILED DESCRIPTION

The following description with reference to the accompanying drawings is provided to assist in a comprehensive understanding of various embodiments of the present disclosure as defined by the claims and their equivalents. It includes various specific details to assist in that understanding but these are to be regarded as merely exemplary. Accordingly, those of ordinary skill in the art will recognize that various changes and modifications of the various embodiments described herein can be made without departing from the scope and spirit of the present disclosure. In addition, descriptions of well-known functions and constructions may be omitted for clarity and conciseness.

The terms and words used in the following description and claims are not limited to the bibliographical meanings, but, are merely used by the inventor to enable a clear and consistent understanding of the present disclosure. Accordingly, it should be apparent to those skilled in the art that the following description of various embodiments of the present disclosure is provided for illustration purpose only and not for the purpose of limiting the present disclosure as defined by the appended claims and their equivalents.

It is to be understood that the singular forms “a,” “an,” and “the” include plural referents unless the context clearly dictates otherwise. Thus, for example, reference to “a component surface” includes reference to one or more of such surfaces.

By the term “substantially” it is meant that the recited characteristic, parameter, or value need not be achieved exactly, but that deviations or variations, including for example, tolerances, measurement error, measurement accuracy limitations and other factors known to those of skill in the art, may occur in amounts that do not preclude the effect the characteristic was intended to provide.

The present disclosure provides a method for controlling a frequency of execution of garbage collection in an electronic device.

The electronic device according to various embodiments of the present disclosure may be one or more of a smart phone, a tablet Personal Computer (PC), a mobile phone, a video phone, an electronic-book reader, a desktop PC, a laptop PC, a netbook computer, a Personal Digital Assistant (PDA), a Portable Multimedia Player (PMP), a Motion Pictures Expert Group (MPEG-1 or MPEG-2) Audio Layer 3 (MP3) player, an accessory, an appcessory, a camera, a wearable device, a wrist watch, a refrigerator, an air-conditioner, a cleaner, an intelligent robot, a television, a Digital Video Disk (DVD) player, a stereo, an oven, a microwave oven, a washing machine, an electronic bangle, an electronic necklace, an air cleaner, and a digital photo frame, a medical equipment, a navigation device, a satellite signal receiver, an Event Data Recorder (EDR), a Flight Data Recorder (FDR), a set-top box, a TV box, an electronic dictionary, a vehicle infotainment device, an electronic equipment for ship, an avionics device, a security equipment, an electronic clothing, an electronic key, a camcorder, a game console, a Head-Mounted Display (HMD), a flat panel display device, an electronic album, a furniture or a portion of a building/structure including an electronic device, an electronic board, an electronic signature receiving device, a protector, and the like, all of which include a memory. It is apparent that the electronic device according to embodiments of the present disclosure is not limited to the above-described devices.

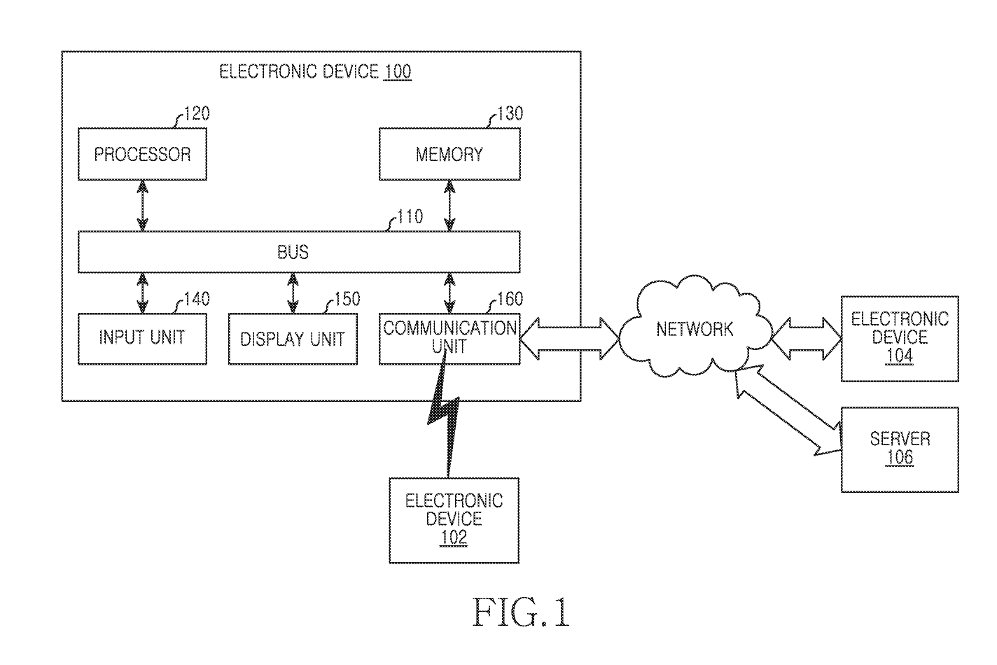

FIG. 1 illustrates a block diagram of an electronic device according to an embodiment of the present disclosure.

Referring to FIG. 1, an electronic device 100 includes a bus 110, a processor 120, a memory 130, an input unit 140, a display unit 150, and a communication unit 160. One or more of the processor 120 and the memory 130 may be provided in plurality.

The bus 110 connects components included in the electronic device 100 to one another and controls communication between the components included in the electronic device 100.

The processor 120 enables the electronic device 100 to provide various services. For example, the processor 120 may decode an instruction received from one or more different components (for example, the memory 130, the input unit 140, the display unit 150, communication unit 160, and the like) and perform data operation or data processing according to the decoded instruction.

The processor 120 may increase an available space of the memory 130 by executing garbage collection on the memory 130. For example, when the memory usage of the memory 130 reaches an event generation reference determined by an execution time-point control variable for garbage collection, the processor 120 may increase an available space of the memory 130 by executing garbage collection on the memory 130 and reclaim the memory resource of storage areas occupied by unusable data (i.e., garbage or object that are no longer in use by the electronic device) included in the memory 130.

When executing garbage collection, the processor 120 may adjust the execution time-point control variable for garbage collection based on a result of garbage collection. For example, the processor 120 may adjust the execution time-point control variable for garbage collection based on the amount of memory resources reclaimed through the garbage collection and a garbage collection cycle. For example, the processor 120 may adjust the execution time-point control variable for garbage collection such that the garbage collection execution cycle is increased when the amount of memory resources reclaimed through garbage collection is less than a proper memory amount. In another example, when the garbage collection cycle is less than a proper cycle, the electronic device 100 may adjust the execution time-point control variable for garbage collection such that the garbage collection execution cycle is increased. When the amount of memory resources reclaimed through garbage collection is greater than a proper memory amount but the garbage collection cycle is less than the proper cycle, the processor 120 may adjust the execution time-point control variable for garbage collection such that the execution cycle for garbage collection is increased. In this case, the garbage collection execution cycle may include a cycle from a time at which a previous garbage collection is executed.

The processor 120 sets an event generation reference for next garbage collection using the execution time-point control variable for garbage collection and the memory usage of the memory 130.

The memory 130 stores an instruction or data received from or generated by one or more components (i.e., the processor 120, the input unit 140, the display unit 150, the communication unit 160, and the like) included in the electronic device 100.

The memory 130 may store one or more programs to be executed by the processor 120 for services of the electronic device 100.

The input unit 140 transmits an instruction or data generated by a user selection to the processor 120 or the memory 130 through the bus 110. For example, the input unit 140 may include at least one of a keypad including at least one hardware button and a touch panel for detecting touch information.

The display unit 150 displays an image, moving images, and data to the user. For example, the display unit 150 may display information about application programs executed by the processor 120.

The communication unit 160 may connect the electronic device 100 to one or more other electronic devices 102 and 104, a server 106, one or more peripheral devices, and the like. For example, the communication unit 160 may support short-range communication protocols (for example, a Wireless Local Area Network (WLAN), a Near-Field Communication (NFC), and the like), or network communication protocols (for example, the Internet, a LAN, a Wire Area Network (WAN), a telecommunication network, a cellular network, a satellite network, a Plain Old Telephone Service (POTS), and the like) or wire communication protocols (for example, a Universal Serial Bus (USB), a High Definition Multimedia Interface (HDMI), and the like). For example, the communication protocol (for example, a short-range communication protocol, a network communication protocol, a wire communication protocol, and the like) may be supported by the middleware of the memory 130 and an Application Programming Interface (API).

In the above-described embodiment of the present disclosure, the processor 120 may adjust the execution time-point control variable for garbage collection within one module.

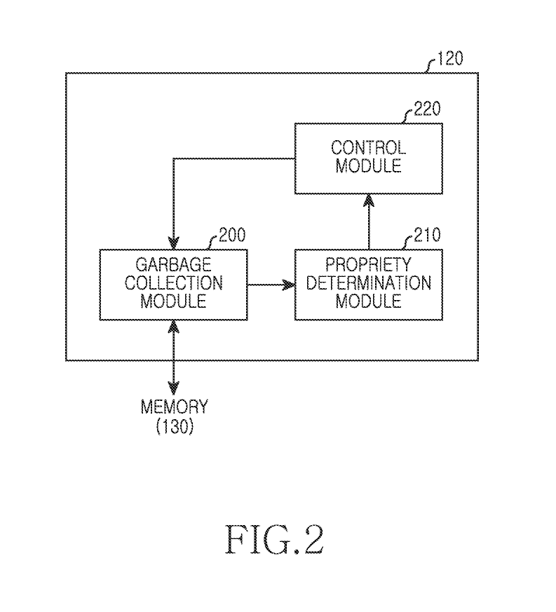

In another embodiment of the present disclosure, the processor 120 may be configured to include separate components for adjusting the execution time-point control variable for garbage collection instead of one component as illustrated in FIG. 2 below.

FIG. 2 illustrates a block diagram of a processor according to an embodiment of the present disclosure.

Referring to FIG. 2, the processor 120 includes a garbage collection module 200, a propriety determination module 210, and a control module 220.

The garbage collection module 200 may increase an available space of the memory 130 by executing garbage collection on the memory 130. For example, when the memory usage of the memory 130 reaches an event generation reference determined by the control module 220, the garbage collection module 200 may increase an available space of the memory 130 by executing garbage collection on the memory 130 and reclaiming the memory resource of storage areas occupied by unusable data (i.e., garbage or object that are no longer in use by the electronic device) included in the memory 130.

The propriety determination module 210 may determine the propriety of the garbage collection executed by the garbage collection module 200. For example, the propriety determination module 210 determines the propriety of the garbage collection executed by the garbage collection module 200 by using one or more of the amount of memory resources reclaimed by the garbage collection module 200 through the garbage collection and a garbage collection cycle. For example, when the amount of the memory resources reclaimed by the garbage collection module 200 through the garbage collection is less than a proper memory amount, the propriety determination module 210 may determine that the garbage collection executed by the garbage collection module 200 is improper. In another example, when the garbage collection cycle of the garbage collection module 200 is less than a proper cycle, the propriety determination module 210 may determine that the garbage collection executed by the garbage collection module 200 is improper. For example, when the amount of the memory resources reclaimed by the garbage collection module 200 through the garbage collection is greater than the proper memory amount but the garbage collection cycle is less than the proper cycle, the propriety determination module 210 may determine that the garbage collection executed by the garbage collection module 200 is improper.

The control module 220 may set the event generation reference for next garbage collection using the garbage collection execution time-point control variable and the memory usage of the memory 130. For example, the control module 220 may set an event generation condition based on the memory utilization and the memory usage of the memory 130 as set forth below in Equation 1.

$${GC}_{NEXT} = {Memory}_{current} + {A}^{′} \\ A = \frac{{Memory}_{current}}{{Memory}_{utilization}} - {Memory}_{current} \\ {A}^{′} = {V}_{MIN} < A < {V}_{MAX} \qquad Equation 1$$

Where GC_{NEXT} denotes an event generation reference for execution of a next garbage collection, Memory_{current} denotes a current memory usage of the memory 130, Memory_{utilization} denotes the memory utilization of the memory 130, and V_{MIN} and V_{MAX} denote the minimum and maximum values of an available memory space.

The control module 220 may adjust the garbage collection execution time-point control variable based on the propriety of the garbage collection determined by the propriety determination module 210. For example, when the propriety determination module 210 determines that the garbage collection executed by the garbage collection module 200 is proper, the control module may maintain the garbage collection execution time-point control variable. For example, when the propriety determination module 210 determines that the garbage collection executed by the garbage collection module 200 is improper, the control module 200 may adjust the garbage collection execution time-point control variable such that the garbage collection execution cycle is increased. For example, the control module 220 may adjust the memory utilization (Memory_{utilization}) of the memory 130 and the minimum and maximum values (V_{MIN} and V_{MAX}) of an available memory space in Equation 1 such that the garbage collection execution cycle is increased.

When the garbage collection execution cycle increases to a maximum garbage collection execution cycle, the control module may initialize the execution time-point control variable for garbage collection. For example, the control module 220 may set the execution time-point control variable for garbage collection to an initial value.

In the above-described embodiment of the present disclosure, the electronic device 100 may adjust the execution time-point control variable for garbage collection by using the processor 120.

In another embodiment of the present disclosure, the electronic device 100 may include a separate control module for adjusting the execution time-point control variable for garbage collection.

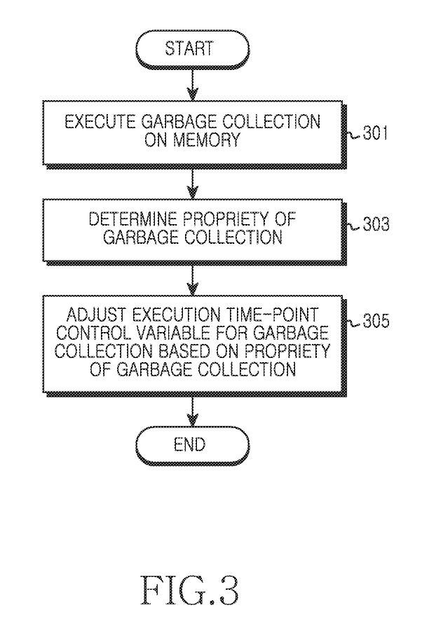

FIG. 3 illustrates a process of adjusting an execution time-point control variable for garbage collection in an electronic device according to an embodiment of the present disclosure.

Referring to FIG. 3, in operation 301, the electronic device 100 may increase an available space of the memory 130 by executing garbage collection on the memory 130 and reclaiming the memory resource of storage areas occupied by unusable data included in the memory 130.

When the garbage collection is executed, the electronic device 100 determines the propriety of the garbage collection in operation 303. For example, the electronic device 100 may determine the propriety of the garbage collection based on the amount of memory resources which is reclaimed through the garbage collection and a garbage collection cycle.

In operation 305, the electronic device 100 adjusts an execution time-point control variable for garbage collection which is used to set an event generation reference for garbage collection based on the propriety of the garbage collection. For example, when the garbage collection is determined as being proper, the electronic device 100 may maintain the execution time-point control variable for garbage collection. In another example, when the garbage collection is determined as being improper, the electronic device 100 may adjust the execution time-point control variable for garbage collection such that the garbage collection execution cycle is increased. For example, the electronic device 100 may adjust the memory utilization (Memory_{utilization}) of the memory 130 and the minimum and maximum values (V_{MIN and V}_{MAX}) of an available memory space, which are used to set the event generation reference such that the garbage collection execution cycle is increased.

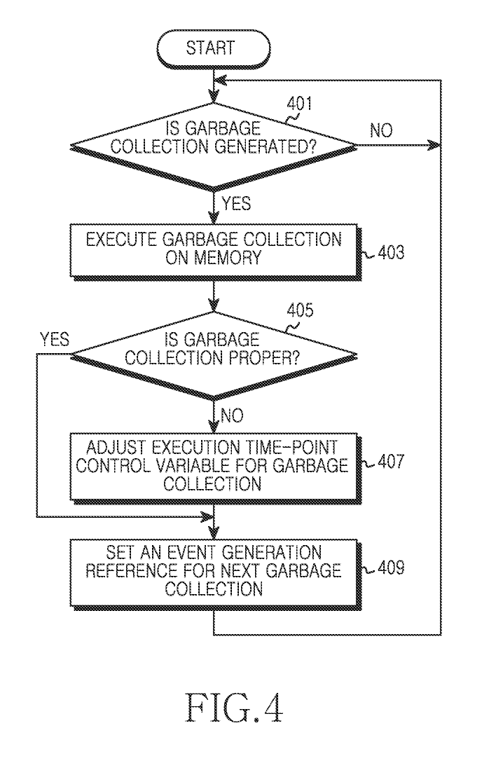

FIG. 4 illustrates a process of adjusting an execution time-point control variable for garbage collection based on a propriety of garbage collection in an electronic device according to an embodiment of the present disclosure.

Referring to FIG. 4, in operation 401, the electronic device 100 determines whether an event for garbage collection is generated. For example, when memory resource is allocated for execution of an application program, the electronic device 100 may determine whether the event for garbage collection occurs by comparing the memory usage of the memory 130 with an event generation reference of garbage collection. When the memory usage of the memory 130 reaches the event generation reference of garbage collection, the electronic device 100 may recognize that the event for garbage collection is generated.

When it is determined in operation 401 that the event for garbage collection does not occur, the electronic device 100 may continuously perform operation 401 to determine whether an event for garbage collection is generated. For example, the electronic device 100 may allocate memory resource for execution of a relevant application program using available memory resource of the memory 130. Thereafter, the electronic device 100 may determine whether an event for garbage collection is generated in operation 401.

On the other hand, when it is determined in operation 401 that the event for garbage collection is generated, the electronic device 100 may increase an available space of the memory 130 by executing garbage collection on the memory 130 and reclaiming the memory resource of storage areas occupied by unusable data included in the memory 130 in operation 403.

When the garbage collection is executed, the electronic device 100 determines whether the garbage collection is proper in operation 405. For example, the electronic device 100 may determine the propriety of the garbage collection based on the amount of memory resources which is reclaimed through the garbage collection and a garbage collection cycle.

When it is determined in operation 405 that the garbage collection is proper, the electronic device 100 may set an event generation reference for next garbage collection in operation 409 by using the execution time-point control variable for garbage collection used to set a previous event generation reference.

On the other hand, when it is determined in operation 405 that the garbage collection is improper, the electronic device 100 adjusts the execution time-point control variable for garbage collection in operation 407 used to set the event generation reference for garbage collection in operation 409. For example, the electronic device 100 may adjust the memory utilization (Memory_{utilization}) of the memory 130 and the minimum and maximum values (V_{MIN} and V_{MAX}) of an available memory space, which are used to set the event generation reference such that the garbage collection execution cycle is increased. As an example, the electronic device 100 may decrease the memory utilization of the memory 130 by 0.2 or increase the maximum value of a variable memory space by 2 MB.

When the execution time-point control variable for garbage collection is adjusted, the electronic device 100 may set an event generation reference for next garbage collection in operation 409 using the execution time-point control variable for garbage collection which has been adjusted in operation 407.

In the above-described embodiment of the present disclosure, garbage collection is executed in order to allocate memory resource for execution of an application program, the electronic device 100 may allocate memory resource for execution of an application program by using available memory resource of the memory 130 which is reclaimed through the garbage collection.

In the above-described embodiment of the present disclosure, when the garbage collection is improper, the electronic device 100 may adjust the execution time-point control variable for garbage collection such that the garbage collection execution cycle is increased. When the garbage collection execution cycle is increased to a maximum garbage collection execution cycle by adjusting the execution time-point control variable for garbage collection, the electronic device 100 may initialize the execution time-point control variable for garbage collection. For example, the electronic device 100 may set the execution time-point control variable for garbage collection to an initial value. In this case, the maximum garbage collection execution cycle may include a garbage collection execution cycle starting at a time-point at which a garbage collection execution time-point set based on an initial value is delayed up to 80% or an event generation reference is increased up to 4 times.

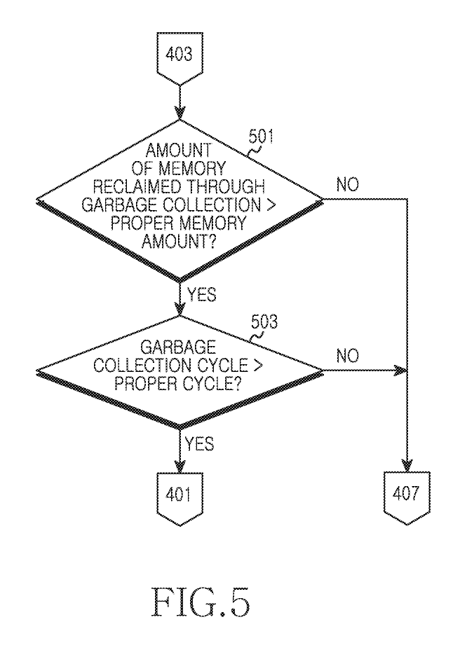

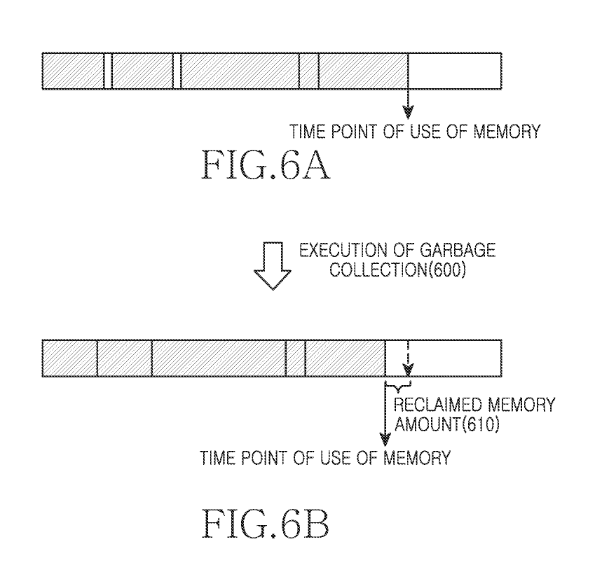

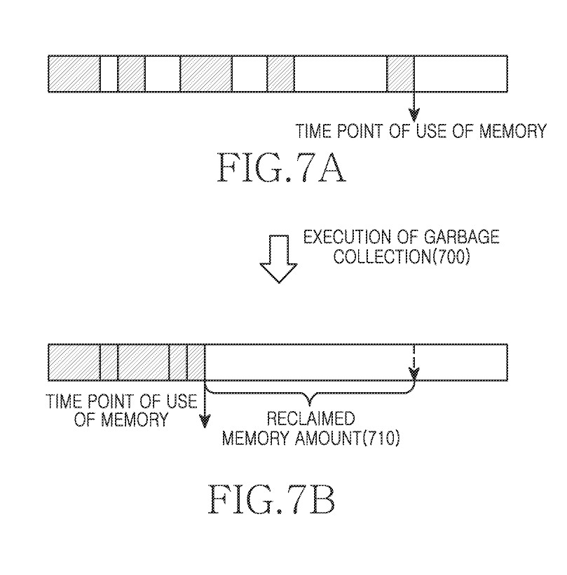

FIG. 5 illustrates a process for determining a propriety of garbage collection in an electronic device according to an embodiment of the present disclosure. The following description focuses on a feature of determining the propriety of garbage collection by using memory configuration illustrated in FIGS. 6A, 6B, 7A, and 7B.

Referring to FIG. 5, when garbage collection is executed on the memory 130 in operation 403 of FIG. 4, the electronic device 100 may determine whether the amount of memory resources reclaimed through the garbage collection is greater than a proper memory amount in operation 501.

When it is determined in operation 501 that the amount of memory resources reclaimed through the garbage collection is equal to or less than the proper memory amount, the electronic device 100 may determine that the garbage collection is improper. Accordingly, the electronic device 100 adjusts an execution time-point control variable for garbage collection in operation 407 of FIG. 4.

FIGS. 6A and 6B illustrate a memory configuration according to garbage collection according to an embodiment of the present disclosure.

Referring to FIGS. 6A and 6B, for example, when garbage collection is executed on the memory 130 in operation 600 as illustrated in FIG. 6A, the electronic device 100 may reclaim the memory resource (610), of which the amount is less than the proper memory amount. In this case, the electronic device 100 may determine that the garbage collection is improper and adjust the execution time-point control variable for garbage collection such that the garbage collection execution cycle is increased.

Referring back to FIG. 5, when it is determined in operation 501 that the amount of memory resources reclaimed through the garbage collection is greater than the proper memory amount, the electronic device 100 may determine whether a garbage collection cycle is greater than a proper cycle in operation 503.

FIGS. 7A and 7B illustrate a memory configuration according to garbage collection according to embodiment of the present disclosure.

Referring to FIGS. 7A and 7B, for example, when garbage collection is executed on the memory 130 in operation 700 as illustrated in FIG. 7A, the electronic device 100 may reclaim the memory resource (710), of which the amount is greater than the proper memory amount. In this case, the electronic device 100 may compare the garbage collection cycle with a proper cycle in order to additionally determine a propriety of garbage collection.

Referring back to FIGS. 4 and 5, when it is determined in operation 503 that the garbage collection cycle is less than or equal to the proper cycle, the electronic device 100 may determine that the garbage collection is improper. Therefore, the electronic device 100 adjusts an execution time-point control variable for garbage collection in operation 407 of FIG. 4. When the amount of memory resources reclaimed through garbage collection is greater than a proper memory amount but the garbage collection cycle is less than the proper cycle, the electronic device 100 may determine that the garbage collection is improper and adjust the execution time-point control variable for garbage collection such that the execution cycle for garbage collection is increased.

When it is determined in operation 503 that the garbage collection cycle is greater than or equal to the proper cycle, the electronic device 100 may determine that the garbage collection is proper. Therefore, the electronic device 100 may set an event generation reference for next garbage collection by using the execution time-point control variable for garbage collection used to set a previous event generation reference the in operation 409 of FIG. 4.

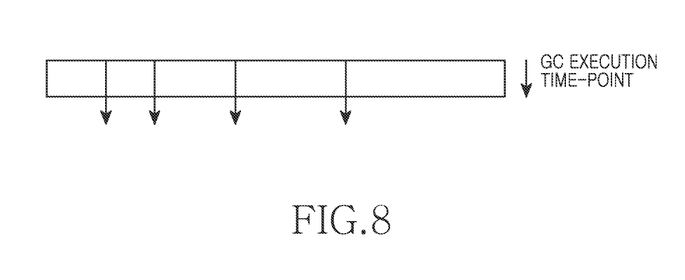

FIG. 8 illustrates a garbage collection execution time-point according to an embodiment of the present disclosure.

Referring to FIG. 8, when garbage collection is improper, the electronic device 100 increases a garbage collection execution cycle by adjusting an execution time-point control variable for garbage collection, thereby reducing the number of execution of unnecessary garbage collection.

As described above, the electronic device 100 adjusts the execution time-point control variable for garbage collection based on a result of garbage collection, thereby reducing the number of execution of unnecessary garbage collection and improving memory efficiency.

Certain aspects of the present disclosure can also be embodied as computer readable code on a non-transitory computer readable recording medium. A non-transitory computer readable recording medium is any data storage device that can store data which can be thereafter read by a computer system. Examples of the non-transitory computer readable recording medium include Read-Only Memory (ROM), Random-Access Memory (RAM), Compact Disc-ROMs (CD-ROMs), magnetic tapes, floppy disks, and optical data storage devices. The non-transitory computer readable recording medium can also be distributed over network coupled computer systems so that the computer readable code is stored and executed in a distributed fashion. In addition, functional programs, code, and code segments for accomplishing the present disclosure can be easily construed by programmers skilled in the art to which the present disclosure pertains.

At this point it should be noted that the various embodiments of the present disclosure as described above typically involve the processing of input data and the generation of output data to some extent. This input data processing and output data generation may be implemented in hardware or software in combination with hardware. For example, specific electronic components may be employed in a mobile device or similar or related circuitry for implementing the functions associated with the various embodiments of the present disclosure as described above. Alternatively, one or more processors operating in accordance with stored instructions may implement the functions associated with the various embodiments of the present disclosure as described above. If such is the case, it is within the scope of the present disclosure that such instructions may be stored on one or more non-transitory processor readable mediums. Examples of the processor readable mediums include a ROM, a RAM, CD-ROMs, magnetic tapes, floppy disks, and optical data storage devices. The processor readable mediums can also be distributed over network coupled computer systems so that the instructions are stored and executed in a distributed fashion. In addition, functional computer programs, instructions, and instruction segments for accomplishing the present disclosure can be easily construed by programmers skilled in the art to which the present disclosure pertains.

While the present disclosure has been shown and described with reference to various embodiments thereof, it will be understood by those skilled in the art that various changes in form and details may be made therein without departing from the spirit and scope of the present disclosure as defined by the appended claims and their equivalents.

What is claimed is:

1. A method in an electronic device, the method comprising:
executing garbage collection on a memory of the electronic device;
determining a propriety of the garbage collection; and
adjusting a control variable for determining an execution time-point of a next garbage collection based on the propriety of the garbage collection.

2. The method of claim 1, wherein the determining of the propriety of the garbage collection is determined by using an amount of memory resources reclaimed through the garbage collection and a garbage collection cycle.

3. The method of claim 2, wherein the determining of the propriety of the garbage collection comprises:
determining that the garbage collection is improper when the amount of memory resources reclaimed through the garbage collection is less than a proper memory amount or when the garbage collection cycle is less than a proper cycle; and
determining that the garbage collection is proper when the amount of memory resources reclaimed through the garbage collection is greater than or equal to a proper memory amount or when the garbage collection cycle is greater than or equal to a proper cycle.

4. The method of claim 1, wherein the adjusting of the control variable comprises updating the control variable such that an execution time-point for the next garbage collection is delayed when the garbage collection is improper.

5. The method of claim 4, wherein the updating of the control variable comprises updating one or more control variables of a memory utilization, a minimum value of an available memory space, and a maximum value of the available memory space, which are used to determine the execution time-point for the next garbage collection.

6. The method of claim 1, wherein the adjusting of the control variable comprises maintaining the control variable of determining the execution time-point for the next garbage collection when the garbage collection is proper.

7. The method of claim 1, further comprising setting an execution time-point for the next garbage collection based on the adjusted control variable and a memory usage of the memory after adjustment of the control variable.

8. An electronic device comprising:
a memory; and
a processor configured to execute garbage collection on the memory and to adjust a control variable for determining an execution time-point of a next garbage collection based on a propriety of the garbage collection.

9. The electronic device of claim 8, wherein the processor comprises:
a collection module configured to execute garbage collection on the memory;
a propriety determination module configured to determine the propriety of the garbage collection executed by the garbage collection module; and
a control module configured to adjust the control variable for determining an execution time-point of the next garbage collection based on the propriety of the garbage collection determined by the propriety determination module.

10. The electronic device of claim 8, wherein the processor is further configured to determine the propriety of the garbage collection by using an amount of memory resources reclaimed through the garbage collection and a garbage collection cycle.

11. The electronic device of claim 10, wherein the processor is further configured to:
determine that the garbage collection is improper when the amount of memory resources reclaimed through the garbage collection is less than a proper memory amount or when the garbage collection cycle is less than a proper cycle, and
determine that the garbage collection is proper when the amount of memory resources reclaimed through the garbage collection is greater than or equal to a proper memory amount or when the garbage collection cycle is greater than or equal to a proper cycle.

12. The electronic device of claim 8, wherein the processor is further configured to update the control variable such that an execution time-point for the next garbage collection is delayed when it is determined that the garbage collection is improper.

13. The electronic device of claim 12, wherein the processor is further configured to update one or more control variables of a memory utilization, a minimum value of an available memory space, and a maximum value of the available memory space, which are used to determine the execution time-point for the next garbage collection.

14. The electronic device of claim 8, wherein the processor is further configured to maintain the control variable of determining the execution time-point for the next garbage collection when it is determined that the garbage collection is proper.

15. The electronic device of claim 8, wherein the processor is further configured to set an execution time-point for the next garbage collection based on the adjusted control variable and a memory usage of the memory.

16. A method for executing garbage collection in an electronic device, the method comprising:
executing garbage collection on a memory of the electronic device;
determining a propriety of the garbage collection; and
when the garbage collection is improper, updating one or more control variables of a memory utilization, a minimum value of an available memory space, and a maximum value of the available memory space, which are used to determine the execution time-point for a next garbage collection.

17. The method of claim 16, further comprising setting an execution time-point for the next garbage collection based on the adjusted control variable and a memory usage of the memory.

18. A non-transitory computer-readable storage medium configured to store a computer program of instructions configured to be readable by at least one processor for instructing the at least one processor to execute a computer process for performing the method of claim 1.
